(19) United States
(12) Patent Application Publication
(10) Pub. No.: US 2016/0025877 A1
(43) Pub. Date: Jan. 28, 2016

(54) METHODS AND SYSTEMS FOR DETERMINING WELL DRILLING PATHS IN A HYDROCARBON FIELD

(71) Applicant: Schlumberger Technology Corporation, Sugar Land, TX (US)

(72) Inventors: Mats Stivang Ramfjord, Tananger (NO); Ahmed Adnan Aqrawi, Tananger (NO); Hallgrim Ludvigsen, Tananger (NO)

(21) Appl. No.: 14/810,552

(22) Filed: Jul. 28, 2015

Related U.S. Application Data
(60) Provisional application No. 62/029,895, filed on Jul. 28, 2014.

(51) Int. Cl. G01V 1/28; E21B 41/00

(52) U.S. Cl. CPC G01V 1/28; E21B 41/0092; G01V 1/40

(57) ABSTRACT

Computing systems, computer-readable media, and methods may include determining, for a hydrocarbon field, a hazard cube that represents one or more hazards associated with drilling a new well in the hydrocarbon field. The method also includes determining one or more drilling constraints for drilling the new well in the hydrocarbon field. Further, the method includes generating a drilling volume for the hydrocarbon field. The drilling volume may comprise a three dimensional representation of one or more areas of the hydrocarbon field that may be drilled to avoid the hazards and satisfy the one or more drilling constraints. Additionally, the method includes displaying the drilling volume for analysis by a user.

### CROSS-REFERENCE TO RELATED APPLICATIONS

This application claims priority to U.S. Provisional Patent Application Ser. No. 62/029,895 filed on Jul. 28, 2014, which is incorporated by reference herein in its entirety.

### BACKGROUND

The placement of new wells in a mature field may be challenging. There may be some uncertainty related to the position of the existing wells, as well as the newly planned well. Other hazards such as faults or salt domes may also be present. Well planners may try to avoid any collisions and other dangers. In a cluster of wells, the well planners may desire to find a path to a target hydrocarbon reservoir that avoids hazards and existing wells.

### SUMMARY

Embodiments of the present disclosure may provide a method. The method includes determining, for a hydrocarbon field, a hazard cube that represents one or more hazards associated with drilling a new well in the hydrocarbon field. The method also includes determining one or more drilling constraints for drilling the new well in the hydrocarbon field. Further, the method includes generating a drilling volume for the hydrocarbon field. The drilling volume may comprise a representation of one or more areas of the hydrocarbon field that may be drilled to avoid the hazards and satisfy the one or more drilling constraints. Additionally, the method includes displaying the drilling volume for analysis by a user.

In an embodiment, the one or more hazards may include one or more of faults in the hydrocarbon field, a path of an existing well in the hydrocarbon field, or a salt dome in the hydrocarbon field.

In an embodiment, the hazard cube may include one or more seismic cubes containing seismic data for the one or more hazards.

In an embodiment, the method may include generating a geobody based at least in part on the drilling volume and a reservoir model that represents reservoir quality of the hydrocarbon field. The method may also include determining, based at least in part on the geobody, one or more drilling paths for the new well that maximize reservoir quality.

In an embodiment, the one or more drilling constraints comprise dogleg severity and starting location of the new well.

In an embodiment, generating the drilling volume may include determining a starting node in a cube. Generating the drilling volume may include selecting an index along the start direction from the starting node and determining whether a hazard in the hazard cube corresponds to the new index. If a hazard corresponds to the new index, the method may include rejecting the new index from inclusion in the drilling volume. If a hazard does not correspond to the new index, the method may include determining whether the new index satisfies at least one of the one or more drilling constraints. If the new index satisfies at least one of the one or more drilling constraints, the method may include including the new index in the drilling volume and selecting a new index in the first direction.

In an embodiment, the first direction comprises one of a vertical direction, a horizontal direction, and a diagonal direction.

Embodiments of the present disclosure may provide a non-transitory computer readable storage medium. The non-transitory computer readable storage medium includes instructions for causing one or more processors to perform a method. The method includes determining, for a hydrocarbon field, a hazard cube that represents one or more hazards associated with drilling a new well in the hydrocarbon field. The method also includes determining one or more drilling constraints for drilling the new well in the hydrocarbon field. Further, the method includes generating a drilling volume for the hydrocarbon field. The drilling volume may comprise a representation of one or more areas of the hydrocarbon field that may be drilled to avoid the hazards and satisfy the one or more drilling constraints. Additionally, the method includes displaying the drilling volume for analysis by a user.

Embodiments of the present disclosure may provide a system. A system includes one or more memory devices storing instructions. The system also includes one or more processors coupled to the one or more memory devices and configured to execute the instructions to perform a method. The method includes determining, for a hydrocarbon field, a hazard cube that represents one or more hazards associated with drilling a new well in the hydrocarbon field. The method also includes determining one or more drilling constraints for drilling the new well in the hydrocarbon field. Further, the method includes generating a drilling volume for the hydrocarbon field. The drilling volume may comprise a representation of one or more areas of the hydrocarbon field that may be drilled to avoid the hazards and satisfy the one or more drilling constraints. Additionally, the method includes displaying the drilling volume for analysis by a user.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIG. 1 illustrates an example of a system that includes various management components to manage various aspects of a geologic environment according to an embodiment.

FIG. 2 illustrates an example of graphical representation of drilling parameters according to an embodiment.

FIG. 3 illustrates an example of a visualization of a well uncertainty according to an embodiment.

FIGS. 4A and 4B illustrate examples of a seismic cube according to an embodiment.

FIG. 5 illustrates an example of a geobody according to an embodiment.

FIG. 6 illustrate a flowchart of a method for determining drilling paths in a hydrocarbon field according to an embodiment.

FIGS. 7A and 7B illustrate examples of hazard cubes according to embodiments.

FIGS. 8A and 8B illustrate examples of saved angle and angle cost according to an embodiment.

FIG. 9 illustrates an example of a drilling volume according to an embodiment.

FIGS. 10A and 10B illustrate flowcharts of a method for generating a drilling volume according to an embodiment.

FIGS. 11A-11G illustrate examples of input used to create a drilling volume and outputted drilling volumes according to an embodiment.

FIG. 12 illustrates a schematic view of a computing system, according to an embodiment.

### DETAILED DESCRIPTION

Reference will now be made in detail to the various embodiments in the present disclosure, examples of which are illustrated in the accompanying drawings and figures. The embodiments are described below to provide a more complete understanding of the components, processes and apparatuses disclosed herein. Any examples given are intended to be illustrative, and not restrictive. However, it will be apparent to one of ordinary skill in the art that the invention may be practiced without these specific details. In other instances, well-known methods, procedures, components, circuits, and networks have not been described in detail so as not to unnecessarily obscure aspects of the embodiments.

Throughout the specification and claims, the following terms take the meanings explicitly associated herein, unless the context clearly dictates otherwise. The phrases “in some embodiments” and “in an embodiment” as used herein do not necessarily refer to the same embodiment(s), though they may. Furthermore, the phrases “in another embodiment” and “in some other embodiments” as used herein do not necessarily refer to a different embodiment, although they may. As described below, various embodiments may be readily combined, without departing from the scope or spirit of the present disclosure.

As used herein, the term “or” is an inclusive operator, and is equivalent to the term “and/or,” unless the context clearly dictates otherwise. The term “based on” is not exclusive and allows for being based on additional factors not described, unless the context clearly dictates otherwise. In the specification, the recitation of “at least one of A, B, and C,” includes embodiments containing A, B, or C, multiple examples of A, B, or C, or combinations of A/B, A/C, B/C, A/B/B/B/B/C, A/B/C, etc. In addition, throughout the specification, the meaning of “a,” “an,” and “the” include plural references. The meaning of “in” includes “in” and “on.”

It will also be understood that, although the terms first, second, etc. may be used herein to describe various elements, these elements should not be limited by these terms. These terms are used to distinguish one element from another. For example, a first object or step could be termed a second object or step, and, similarly, a second object or step could be termed a first object or step, without departing from the scope of the invention. The first object or step, and the second object or step, are both, objects or steps, respectively, but they are not to be considered the same object or step. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof Further, as used herein, the term “if” may be construed to mean “when” or “upon” or “in response to determining” or “in response to detecting,” depending on the context.

When referring to any numerical range of values herein, such ranges are understood to include each and every number and/or fraction between the stated range minimum and maximum. For example, a range of 0.5-6% would expressly include intermediate values of 0.6%, 0.7%, and 0.9%, up to and including 5.95%, 5.97%, and 5.99%. The same applies to each other numerical property and/or elemental range set forth herein, unless the context clearly dictates otherwise.

Attention is now directed to processing procedures, methods, techniques, and workflows that are in accordance with some embodiments. Some operations in the processing procedures, methods, techniques, and workflows disclosed herein may be combined and/or the order of some operations may be changed.

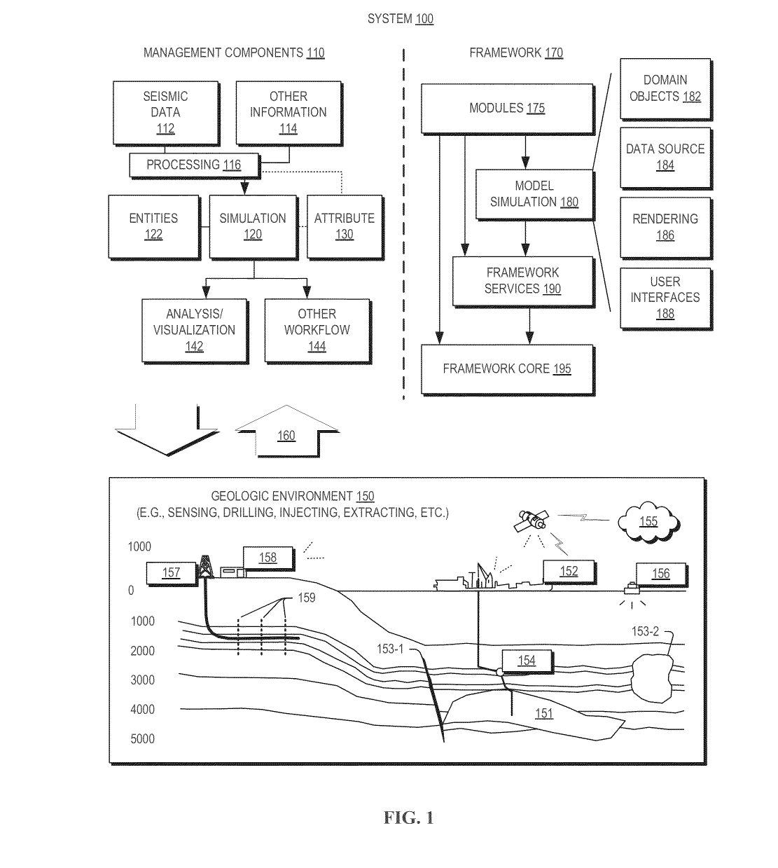

FIG. 1 illustrates an example of a system 100 that includes various management components 110 to manage various aspects of a geologic environment 150 (e.g., an environment that includes a sedimentary basin, a reservoir 151, one or more faults 153-1, one or more geobodies 153-2, etc.). For example, the management components 110 may allow for direct or indirect management of sensing, drilling, injecting, extracting, etc., with respect to the geologic environment 150. In turn, further information about the geologic environment 150 may become available as feedback 160 (e.g., optionally as input to one or more of the management components 110).

In the example of FIG. 1, the management components 110 include a seismic data component 112, an additional information component 114 (e.g., well/logging data), a processing component 116, a simulation component 120, an attribute component 130, an analysis/visualization component 142 and a workflow component 144. In operation, seismic data and other information provided per the components 112 and 114 may be input to the simulation component 120.

In an example embodiment, the simulation component 120 may rely on entities 122. Entities 122 may include earth entities or geological objects such as wells, surfaces, bodies, reservoirs, etc. In the system 100, the entities 122 may include virtual representations of actual physical entities that are reconstructed for purposes of simulation. The entities 122 may include entities based on data acquired via sensing, observation, etc. (e.g., the seismic data 112 and other information 114). An entity may be characterized by one or more properties (e.g., a geometrical pillar grid entity of an earth model may be characterized by a porosity property). Such properties may represent one or more measurements (e.g., acquired data), calculations, etc.

In an example embodiment, the simulation component 120 may operate in conjunction with a software framework such as an object-based framework. In such a framework, entities may include entities based on pre-defined classes to facilitate modeling and simulation. A commercially available example of an object-based framework is the MICROSOFT® .NET® framework (Redmond, Wash.), which provides a set of extensible object classes. In the .NET® framework, an object class encapsulates a module of reusable code and associated data structures. Object classes may be used to instantiate object instances for use in by a program, script, etc. For example, borehole classes may define objects for representing boreholes based on well data.

In the example of FIG. 1, the simulation component 120 may process information to conform to one or more attributes specified by the attribute component 130, which may include a library of attributes. Such processing may occur prior to input to the simulation component 120 (e.g., consider the processing component 116). As an example, the simulation component 120 may perform operations on input information based on one or more attributes specified by the attribute component 130. In an example embodiment, the simulation component 120 may construct one or more models of the geologic environment 150, which may be relied on to simulate behavior of the geologic environment 150 (e.g., responsive to one or more acts, whether natural or artificial). In the example of FIG. 1, the analysis/visualization component 142 may allow for interaction with a model or model-based results (e.g., simulation results, etc.). As an example, output from the simulation component 120 may be input to one or more other workflows, as indicated by a workflow component 144.

As an example, the simulation component 120 may include one or more features of a simulator such as the ECLIPSE™ reservoir simulator (Schlumberger Limited, Houston Tex.), the INTERSECT™ reservoir simulator (Schlumberger Limited, Houston Tex.), etc. As an example, a simulation component, a simulator, etc. may include features to implement one or more meshless techniques (e.g., to solve one or more equations, etc.). As an example, a reservoir or reservoirs may be simulated with respect to one or more enhanced recovery techniques (e.g., consider a thermal process such as SAGD, etc.).

In an example embodiment, the management components 110 may include features of a commercially available framework such as the PETREL® seismic to simulation software framework (Schlumberger Limited, Houston, Tex.). The PETREL® framework provides components that allow for optimization of exploration and development operations. The PETREL® framework includes seismic to simulation software components that may output information for use in increasing reservoir performance, for example, by improving asset team productivity. Through use of such a framework, various professionals (e.g., geophysicists, geologists, and reservoir engineers) may develop collaborative workflows and integrate operations to streamline processes. Such a framework may be considered an application and may be considered a data-driven application (e.g., where data is input for purposes of modeling, simulating, etc.).

In an example embodiment, various aspects of the management components 110 may include add-ons or plug-ins that operate according to specifications of a framework environment. For example, a commercially available framework environment marketed as the OCEAN® framework environment (Schlumberger Limited, Houston, Tex.) allows for integration of add-ons (or plug-ins) into a PETREL® framework workflow. The OCEAN® framework environment leverages .NET® tools (Microsoft Corporation, Redmond, Wash.) and offers stable, user-friendly interfaces for efficient development. In an example embodiment, various components may be implemented as add-ons (or plug-ins) that conform to and operate according to specifications of a framework environment (e.g., according to application programming interface (API) specifications, etc.).

FIG. 1 also shows an example of a framework 170 that includes a model simulation layer 180 along with a framework services layer 190, a framework core layer 195 and a modules layer 175. The framework 170 may include the commercially available OCEAN® framework where the model simulation layer 180 is the commercially available PETREL® model-centric software package that hosts OCEAN® framework applications. In an example embodiment, the PETREL® software may be considered a data-driven application. The PETREL® software may include a framework for model building and visualization.

As an example, a framework may include features for implementing one or more mesh generation techniques. For example, a framework may include an input component for receipt of information from interpretation of seismic data, one or more attributes based at least in part on seismic data, log data, image data, etc. Such a framework may include a mesh generation component that processes input information, optionally in conjunction with other information, to generate a mesh.

In the example of FIG. 1, the model simulation layer 180 may provide domain objects 182, act as a data source 184, provide for rendering 186 and provide for various user interfaces 188. Rendering 186 may provide a graphical environment in which applications may display their data while the user interfaces 188 may provide a common look and feel for application user interface components.

As an example, the domain objects 182 may include entity objects, property objects and optionally other objects. Entity objects may be used to geometrically represent wells, surfaces, bodies, reservoirs, etc., while property objects may be used to provide property values as well as data versions and display parameters. For example, an entity object may represent a well where a property object provides log information as well as version information and display information (e.g., to display the well as part of a model).

In the example of FIG. 1, data may be stored in one or more data sources (or data stores, generally physical data storage devices), which may be at the same or different physical sites and accessible via one or more networks. The model simulation layer 180 may be configured to model projects. As such, a particular project may be stored where stored project information may include inputs, models, results and cases. Thus, upon completion of a modeling session, a user may store a project. At a later time, the project may be accessed and restored using the model simulation layer 180, which may recreate instances of the relevant domain objects.

In the example of FIG. 1, the geologic environment 150 may include layers (e.g., stratification) that include a reservoir 151 and one or more other features such as the fault 153-1, the geobody 153-2, etc. As an example, the geologic environment 150 may be outfitted with any of a variety of sensors, detectors, actuators, etc. For example, equipment 152 may include communication circuitry to receive and to transmit information with respect to one or more networks 155. Such information may include information associated with downhole equipment 154, which may be equipment to acquire information, to assist with resource recovery, etc. Other equipment 156 may be located remote from a well site and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 1 shows a satellite in communication with the network 155 that may be configured for communications, noting that the satellite may include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

As mentioned, the system 100 may be used to perform one or more workflows. A workflow may be a process that includes a number of worksteps. A workstep may operate on data, for example, to create new data, to update existing data, etc. As an example, a may operate on one or more inputs and create one or more results, for example, based on one or more algorithms. As an example, a system may include a workflow editor for creation, editing, executing, etc. of a workflow. In such an example, the workflow editor may provide for selection of one or more pre-defined worksteps, one or more customized worksteps, etc. As an example, a workflow may be a workflow implementable in the PETREL® software, for example, that operates on seismic data, seismic attribute(s), etc. As an example, a workflow may be a process implementable in the OCEAN® framework. As an example, a workflow may include one or more worksteps that access a module such as a plug-in (e.g., external executable code, etc.).

As described above, the system 100 may be used to simulate or model a geologic environment 150 and/or a reservoir 151. In embodiments, the system 100 may be used in field development planning In embodiments, the system 100 may be used to determine available drilling paths in a hydrocarbon field (“field”) that avoid hazards in the field and meet one or more drilling constraints. The system 100 may be used to generate a drilling volume. The drilling volume may be a three-dimensional (“3D”) representation of possible drilling paths in the field that avoid the hazards. In embodiments, the drilling volume may be a 3D volume, stored as a seismic cube or geobody, that shows where it may be possible to drill. The drilling volume may provide a complete volume that illustrates areas where a new well can traverse unobstructed. In embodiments, to calculate the drilling volume, the system 100 may use a hazard cube to represent the hazards in the field. The hazard cube may be a 3D representation of one or more hazards in the field to be avoided in the available drill paths.

In embodiments, when determining the drilling volume, constraints of the drilling operation may be considered. A well may be drilled vertically from the surface. The well may be vertical the entire length of the well, or deviate at a predefined depth, for example, in directional drilling. The path of the well may be formed in many ways and may be governed by the drilling equipment that is being used. For example, dogleg severity (“DLS”) may govern how “quickly” a well may turn and may be determined by the drilling equipment.

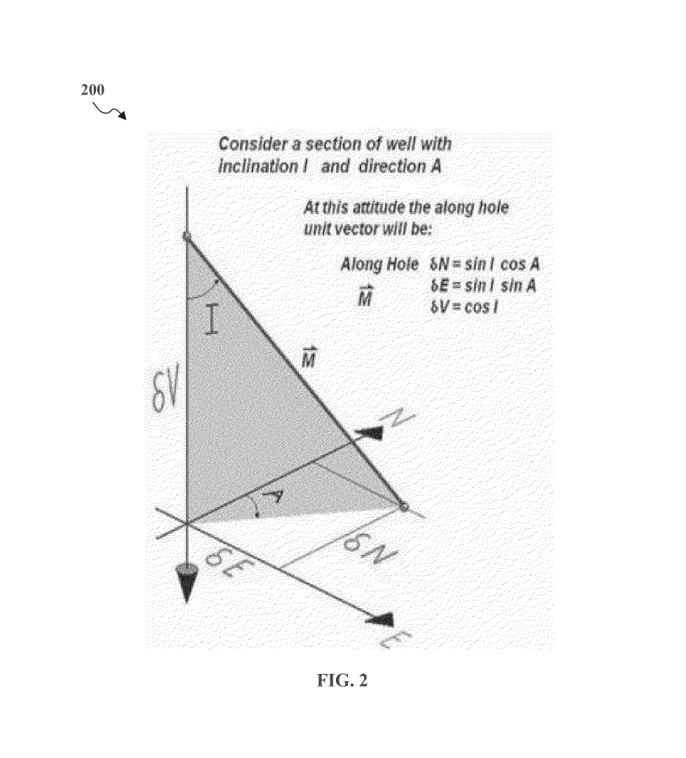

In embodiments, parameters may be used to describe the measured position of a well: measured depth (“MD”), azimuth (“A”) and inclination (“I”). Azimuth and inclination may be calculated from other measurements. MD may be measured by equipment at the field. The three parameters may be used to describe the position of a well. The three parameters may also be used to calculate northing (N), easting (E) and true vertical depth (TVD). Measurements while drilling (“MWD”) tools may be used to measure depth. MD may be measured at the surface and may describe the length of the well. TVD may vary from MD if the well is drilled directionally. Azimuth may describe the compass direction and may be specified in degrees with respect to the geographic or magnetic north pole. Azimuth may be measured using magnetic surveying tools, such as magnetometers. Inclination may describe how much the well deviates from vertical direction and may be given in angles. Inclination may be measured with accelerometers and/or gyroscopes. FIG. 2 illustrates an example of a graphical representation 200 of the three parameters. In directional drilling, a severe dogleg may be characterized as a sudden change in angle or direction. The dogleg may cause a pipe to get stuck in the wellbore. To avoid this, DLS may be controlled while drilling. DLS may be given in, for example, degrees per 100 ft. or degrees per 30 m. DLS may be calculated using measured depth, inclination and azimuth.

In embodiments, the hazards may include any obstacle to the creation of a new well. For example, the hazards may include faults in the field, estimated locations of existing wells, salt domes, and other types of hazards located in the field. A fault may include a “plane of failure” in a rock caused by stress. Faults may be observed on seismic sections, shaped as curves or lines. Faults may, for example, cover hundreds of kilometers of a field. When planning a new well in a field, the new well may avoid drilling into faults, as they may affect the new well. In some embodiments, the faults in a field may be represented by one or more seismic cubes.

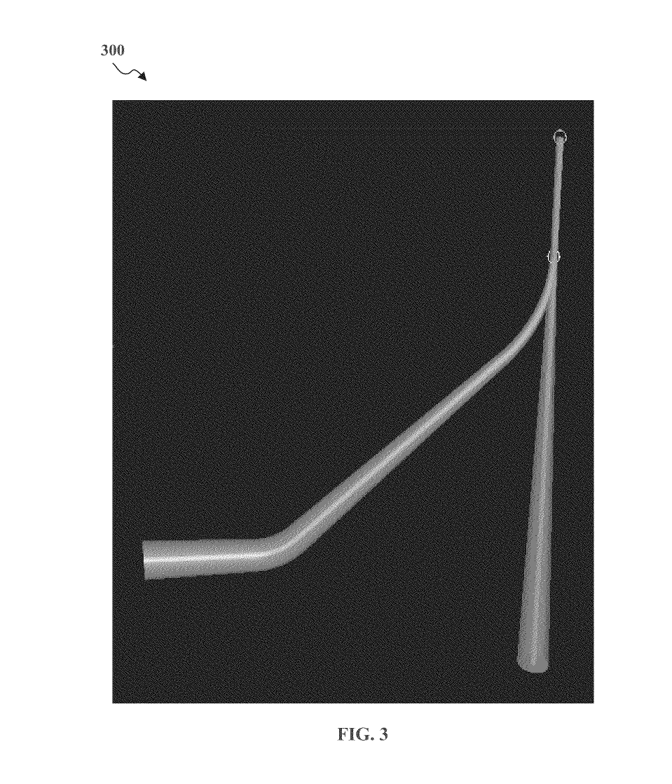

In some embodiments, the hazards may include an estimated location of existing wells in the field. The locations of existing wells may include position uncertainty. An error in azimuth may create a 3D ellipse of uncertainty. Because of an error in azimuth, position uncertainty may be smaller in vertical wells than in deviated wells. Position uncertainty may be visualized with a cone along the path of a well. If the cones of a proposed well and an existing well intersect, there may be a collision risk. FIG. 3 illustrates an example visualization 300 of the position uncertainty in a well. In some embodiments, the location of existing wells and position uncertainty may be used as input to create hazard cubes.

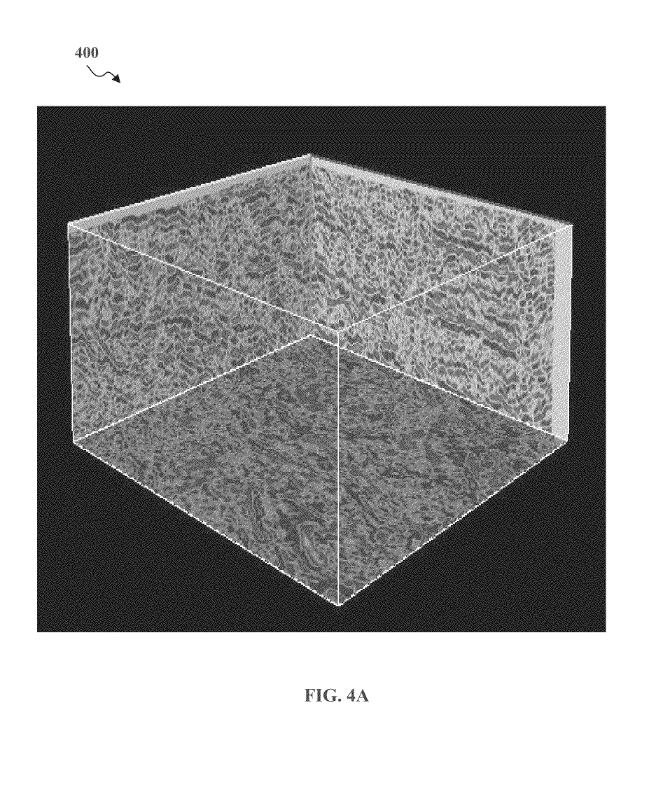

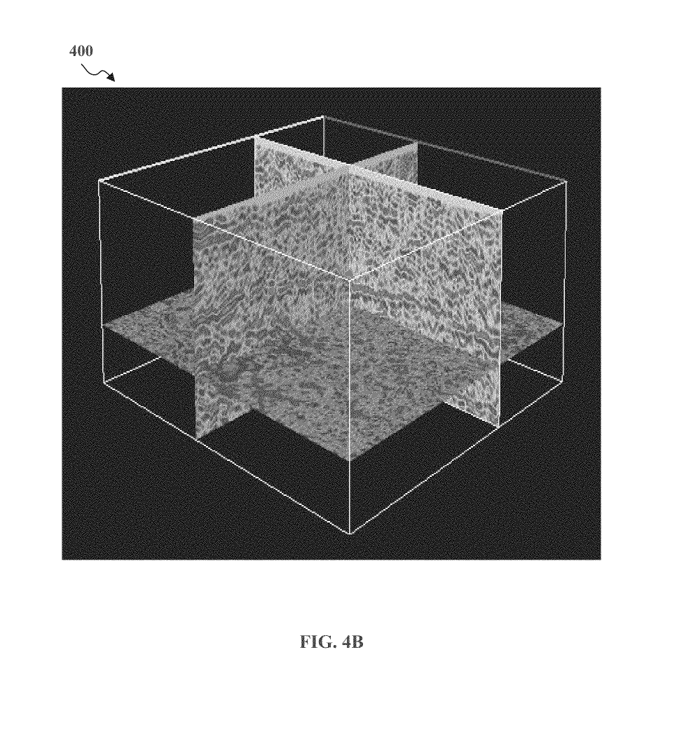

In some embodiments, a hazard cube may be created one or more of seismic cubes or geobodies that represent the hazards. Seismic cubes may be used for displaying seismic data. For a field, the seismic cube may be three dimensional (“3D”) representation of the seismic data that describes the geology of the field. A single seismic cube may consist of many cells. Each cell of the seismic cube may have a given three-dimensional index (i, j, k) that describes the relative position of the cell. Each cell also has a value assigned to it that represents the geologic properties for the field at the relative position of the cell. FIG. 4A represents one example of a seismic cube 400. The seismic cube 400 may consist of about, for example, 6.4 million cells, each with a given index. Any part of a seismic cube may be displayed by interactively changing the position of a slice. FIG. 4B shows the seismic cube 400 where the position of the slices has been changed, such that other parts of the cube are displayed. Vertical sections may be chosen as well as horizontal sections. It may also be possible to show any kind of section by using so-called random sections.

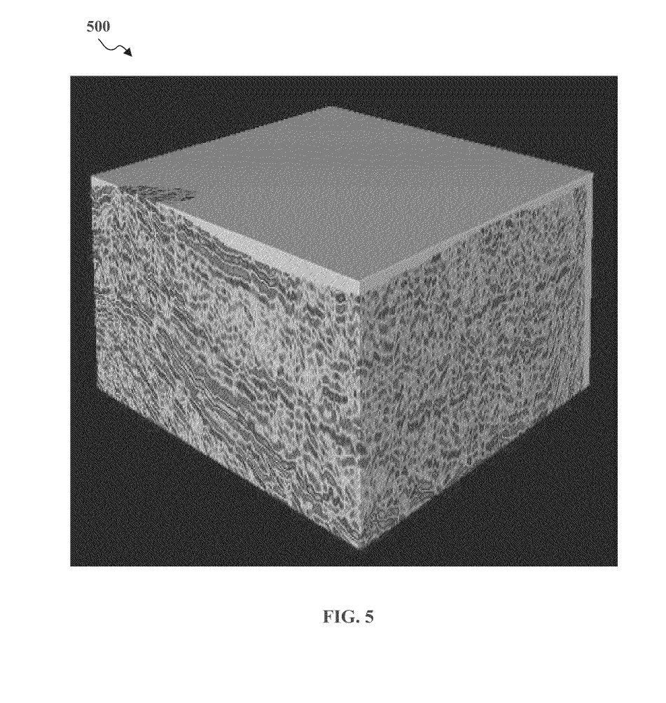

A geobody may be a process to visualize seismic data. A geobody may be created from a seismic cube. The geobody may allow a complete seismic cube to be represented and viewed as a complete volume, instead of only showing certain sections at a time. FIG. 5A illustrates an example of a geobody 500. The geobody may also be configured to specify some parts of the data set that should not be visible. This way, one may, for example, hide all values below a given threshold by setting the opacity to zero. Another possibility may be to cross-plot two or more cubes in the same geobody, for example, showing two or more different attributes at the same time.

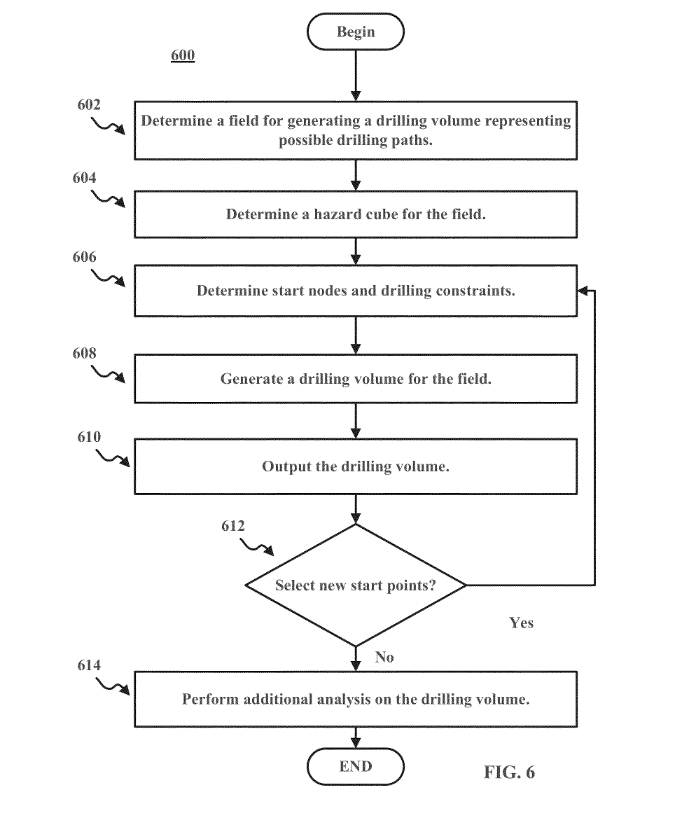

FIG. 6 illustrates a flowchart of a method 600 for determining a drilling volume that avoids hazards while satisfying drilling constraints. The illustrated stages of the method are examples and that any of the illustrated stages may be removed, additional stages may be added, and the order of the illustrated stages may be changed.

In 602, a field may be determined for which to generate a drilling volume representing different possible drilling paths. In some embodiments, for example, a user of the system 100 may select a field to evaluate and generate a drilling volume. In some embodiments, for example, the system 100 may automatically select a field for evaluation.

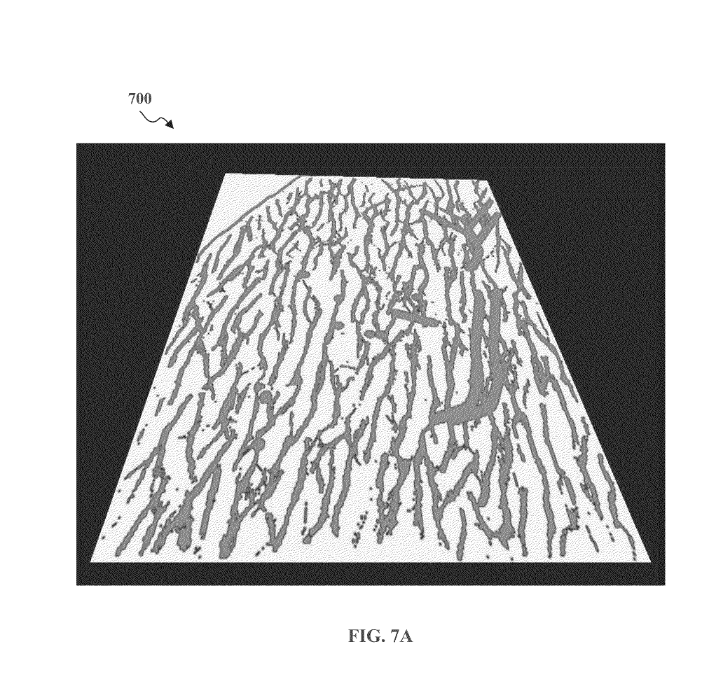

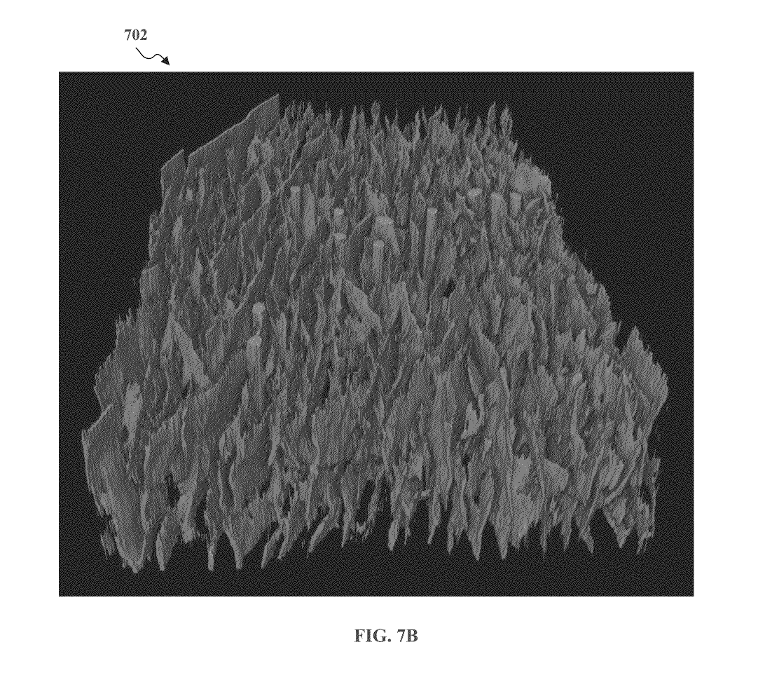

In 604, a hazard cube for the field may be determined. In some embodiments, the hazards cube may include different hazards in the field, for example, faults, existing wells, salt domes and the like. In embodiments, a hazard cube may be a seismic cube where the values indicate whether there is a hazard at an index or not. The values may be binary: a value of 1 means there is a hazard at an index and a value of 0 means no hazard. In some embodiments, one hazard cube may be created for each type of hazard. In some embodiments, the hazard cubes for the different types of hazards may be merged into a single hazard cube that may be used in the generation of the drilling volume. FIG. 7A illustrates an example of a time slice 700 of a hazard cube with some wells and a large amount of faults. As illustrated in FIG. 7A, the hazards may be represented as dark areas, while white indicates “no hazard.” FIG. 7B illustrates an example of the hazard cube visualized as a geobody.

In 606, starting nodes and drilling constraints may be determined. In some embodiments, a user may specify one or more starting nodes. In some embodiments, one or more starting nodes may be automatically created. For example, a set of start nodes may be created where the azimuth of the start nodes are evenly spread out between 0-360 degrees. This may be done to make sure that all azimuth directions are covered in the early stages of the computation. For example, a set of eight start nodes may be created wherein the azimuth of the start nodes are evenly spaced at 45 degree increments.

In some embodiments, a user may specify one or more drilling constraints. In some embodiments, one or more drilling constraints may be predetermined. In some embodiments, the drilling constraints may include DLS limitations.

In 608, the drilling volume may be generated using the hazard cube, the starting nodes, and the one or more drilling constraints. In some embodiments, for example, the drilling volume may be generated by planting one or more nodes in a seismic cube at the position where a new well may be placed. The one or more nodes may then traverse the seismic cube while trying to simulate the movement of real drilling. The seismic cube may be considered as a low-resolution 3D grid. While moving between indexes in the seismic cube, the process may move in circular arcs that are as smooth as possible. The DLS may be used to control the curvature of the arcs. The DLS may controls when a node may turn, for example, change index in a perpendicular direction to its current (grid) direction.

In some embodiments, accumulated angle may be used to decide when a node may turn. While a node is moving without changing its direction, the process accumulates an angle (“a saved angle”). In some embodiments, a node may have traveled far enough to split into more nodes when its saved angle is higher than the angle cost. Saved angle may be defined the accumulated angle as a node moves in one direction. The accumulation rate of the saved angle, determined by the input DLS, may be calculated as:

saved angle=traveled distance—DLS

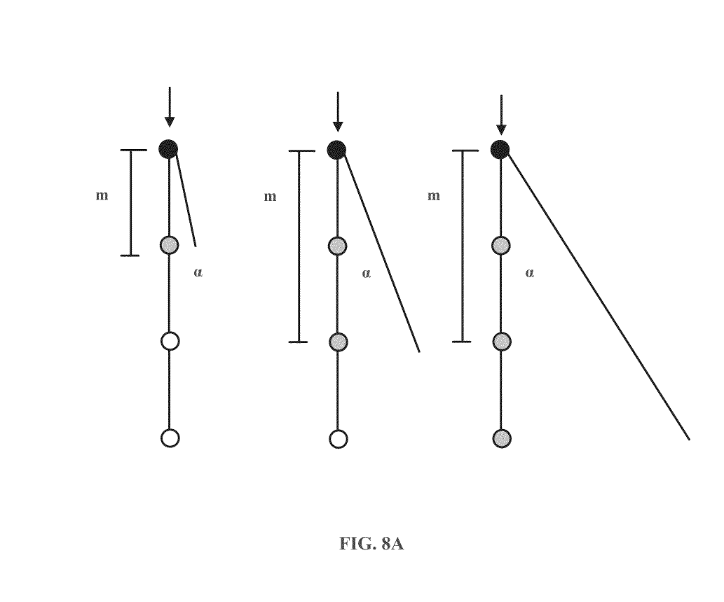

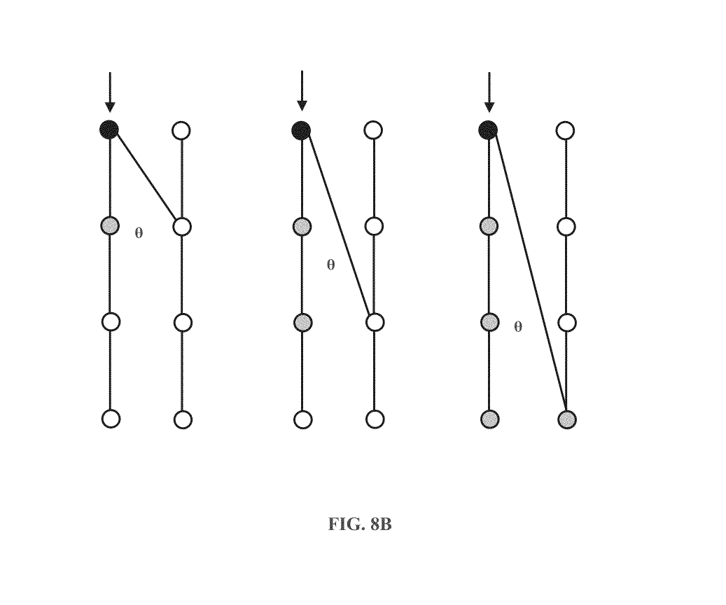

FIG. 8A illustrates an example of the accumulation of the saved angle. As illustrated in FIG. 8A, saved angle may be denoted by a, and a traveled distance may be denoted by m. The dark shaded circle may show where the current node is created, for example, the same position as the parent node. Unshaded may indicate not visited and lightly shaded may indicated visited or possible to visit. The arrow shows the direction of the current node. As illustrated, the saved angle may increases as the traveled distance increases.

In some embodiments, the saved angle may be used to decide if the node may turn or not. To check if the saved angle may be large enough, the saved angle compared to an angle cost. Angle cost may be either inclination cost or azimuth cost. The angle cost describes, in terms of an angle, how much the inclination or azimuth of the current node must change in order to move to a given test index. FIG. 8B illustrates an example of determining angle cost for inclination. The same principle may be used to find azimuth cost. As illustrated, inclination cost θ may be given by the inclination change needed to move to another (deviated) index. The parent node may be indicated by the darkly shaded circle. The unshaded circle may indicate not visited, while the lightly shaded circle may indicates visited. The arrow shows the direction (inclination) of the current node. In the diagram on the left of FIG. 8B, the current node may be visited one index below the parent node, and it was marked. The test index (horizontal to the current node) was not possible to visit, since the inclination cost was too high. In the diagram in the middle of FIG. 8B, the node has continued along the same direction and visited another index. This may also be marked with as lightly shaded. The inclination cost to the new test index (horizontal to the current node) was still too high. In the diagram on the right of FIG. 8B, the current node may visit a third index and marked as lightly shaded. This time, the saved angle may be larger than the inclination cost, so the node could jump to the test index (the test index was successful and lightly shaded). After this, the current node may be split into more nodes and the process may continue.

When the saved angle is larger than the angle cost, the node may turn. Whenever a node does a turn, the process may change direction, for example, inclination and/or azimuth, and may split into more nodes. The new nodes may get new directions that the process may move along.

For example, when the saved angle becomes higher than the angle cost, new nodes may be created at a successful test index. The new nodes have other directions than the previous node, for example, different inclination and/or azimuth values. The inclination value of the new node may be given by the direction from the previous node to the new node. The same applies for azimuth. Now the cycle is repeated; the new nodes will move along their new directions until they may split into more nodes, and so on. While moving, the process may accumulate an angle each until they may do a turn. The process continues until all reachable indexes are marked, or until the computation is terminated in other ways.

In some embodiments, for example, as each node is traversed and new indexes may be selected, the process checks to determine if the hazard cube at that nodes indicates a hazard. If so, the node may be discarded and that direction may be terminated.

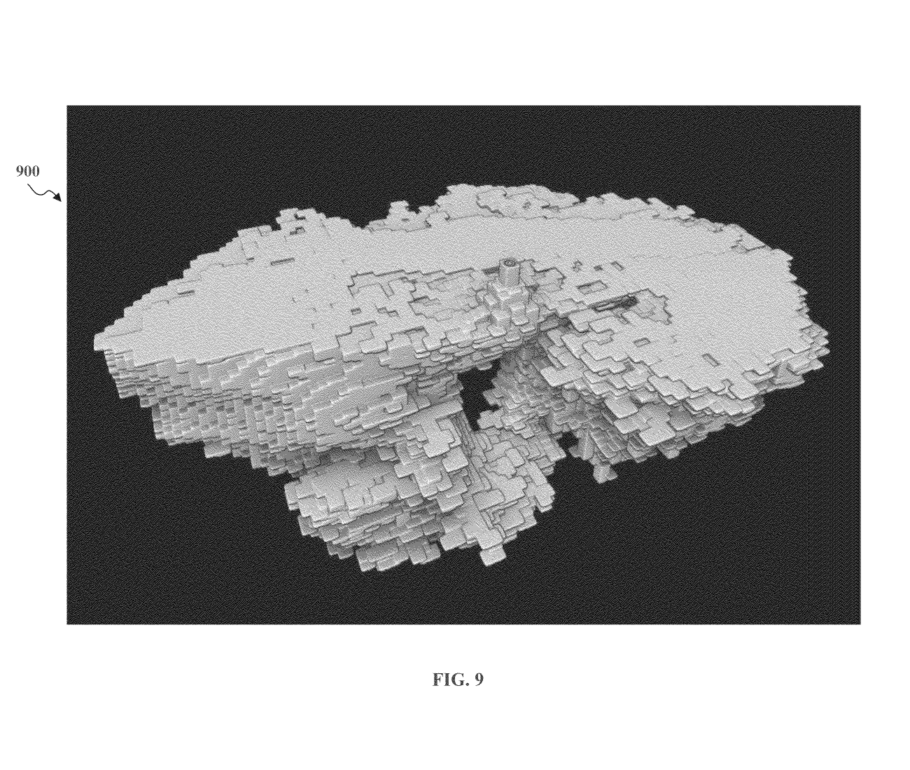

In some embodiments, whenever a node visits an index (meets the drilling constraints and no hazards), the index may be marked in the seismic cube, indicating that it is a possible drilling path. FIG. 9 illustrates an example of drilling volume generated according to the process.

In 610, once the drilling volume is generated, the drilling volume may be output. In some embodiments, the drilling volume may be displayed, for example, by system 100. In some embodiments, the drilling volume may be stored for further processing and analysis. In some embodiments, the drilling volume may be transmitted to other computer systems for display, storage, and further processing and analysis.

In some embodiments, when a drilling volume has been generated, the drilling volume may be displayed and/or stored as a seismic cube. When a drilling volume is visualized as a seismic cube, a single section of the cube may be selected to display. This may be useful to focus on a small part of the volume. A seismic cube may be used to interactively switch between sections to get an overview of the whole volume.

In some embodiments, when a drilling volume has been generated, may be displayed and/or stored as a geobody. For example, the seismic cube may be converted into a geobody. The geobody may allow display all of the drilling volume at the same time as a 3D figure. This way of visualizing the drilling volume may be useful when a quick overview of an area is required. By cropping a geobody to an appropriate size, it may possible to get a view and understanding of how a certain part of the volume was reached. On the other hand, it may also possible to see why an area was not reached.

In 612, one or more new starting nodes may be selected to generate a drilling volume. For example, a new location for the well may be selected for the field. If one or more new starting nodes are selected, the process may return to 606 and repeat. Otherwise the method 600 may proceed to 614.

In 614, other analysis may be performed on the drilling volume. For example, a geobody of the drilling volume may be used to cross-plot two or more seismic cubes. For instance, the drilling volume may be merged with one or more seismic cubes into one volume. In some embodiments, the drilling volume may be used to cross-plot a seismic cube that indicates high reservoir quality. This results in a geobody that shows reachable and drillable areas with high reservoir quality. In some embodiments, the drilling volume may be used to cross-plot a seismic cube that the hazards, for example, the hazard cube. This way of visualizing the drilling volume may be useful when a quick overview of an area may be required. By cropping a geobody to an appropriate size, it may possible to get a view and understanding of how a certain part of the volume was reached. On the other hand, it may also possible to see why an area was not reached.

In some embodiments, the opacity settings of the geobody may be varied to view different data contained in the geobody. By changing the opacity for certain values, for example, interior parts of a geobody may be displayed.

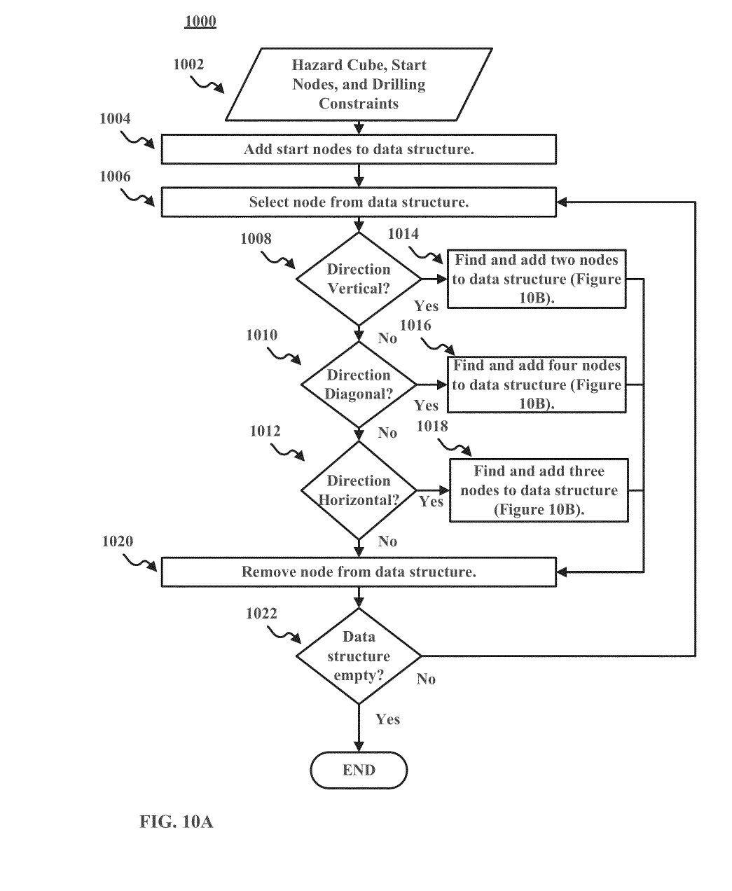

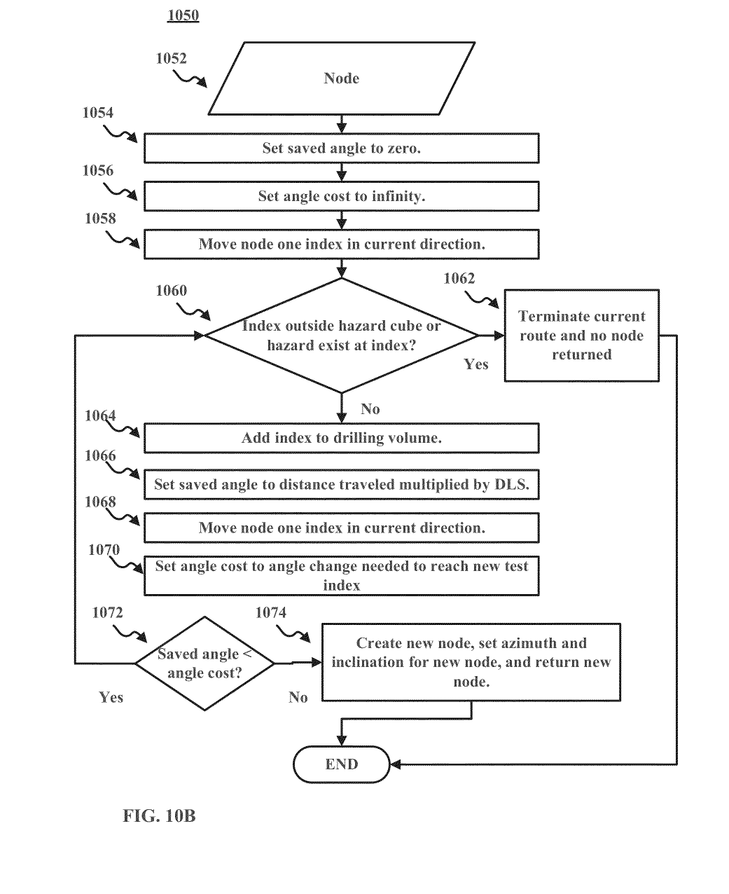

FIGS. 10A and 10B illustrate flowcharts of a method 1000 for generating a drilling volume using the hazard cube and drilling constraints. The method 1000 may be used in stage 608 described above. The illustrated stages of the method are examples and that any of the illustrated stages may be removed, additional stages may be added, and the order of the illustrated stages may be changed.

In 1002, the hazard cube, start nodes, and drilling constraints are input. In 1004, the start nodes may be added to a data structure. In some embodiments, the data structure may be a queue that nodes are added to once the nodes are created. When the method 100 is finished with one node, a new node may be popped from the queue and may be evaluated. The queue may works as a first in-first out (“FIFO”) queue. In some embodiments, the data structure of all evaluated nodes may be in-memory during the computation and may resemble a rooted tree. The method 1000 may traverse the solution space similar to a breadth-first search (“BFS”).

In 1006, a node may be selected from the data structure. In some embodiments, for the FIFO queue, the node at the top of the queue is selected for evaluation. In 1008, 1010, and 1012, the direction of the node may be determined. In some embodiments, limited node splitting may be used to reduce the total number of nodes. Rules may also ensure that a node may never mode upwards to avoid infinite loops. The rules may also provide necessary new directions that are needed to move around in the seismic cube in a fairly realistic way. For example, one node may split into 2, 4 and 3 nodes when moving vertically, diagonally and horizontally, respectively.

In 1008, for example, if the direction is vertical, two nodes may be found and added to the data structure in 1014. In some embodiments, the direction of a node may be called vertical when its inclination is between 0-30 degrees. When moving vertically, the node may split into two new nodes:

1. One node may increase inclination.

2. One node may decrease inclination.

In 1010, for example, if the direction is diagonal, four nodes may be found and added to the data structure in 1016. In some embodiments, a node may be moving diagonally when the inclination is between 30-60 degrees. When the direction is diagonal, the node may split into four new nodes:

1. One node may increase inclination.

2. One node may decrease inclination.

3. One node may increase azimuth.

4. One node may decrease azimuth.

In 1012, for example, if the direction is horizontal, three nodes may be found and added to the data structure in 1018. In some embodiments, when the inclination of a node is between 60-90 degrees, the node may be moving horizontally. The node may be split into three new nodes:

1. One node may decrease inclination.

2. One node may increase azimuth.

3. One node may decrease azimuth.

In 1020, it may be determined if the data structure is empty. If the data structure is empty, the method 1000 may end. If the data structure is not empty, the method 1000 returns to 1006 and a new node may be selected and processed.

FIG. 10B illustrates stages of a method 1050 of generating and checking new nodes to traverse the hydrocarbon field. In 1052, the node may be input. In 1054, the saved angle may be set to zero. In 1056, the angle cost may be set to infinity. In 1058, the new node may be moved one index position in the current direction.

In 1060, it may be determined if the new index is outside the hazard cube or a hazard exists at the index. If the new index is outside the hazard cube or a hazard exists, the current route may be terminated and no new node is returned in 1062. The method 1050 may then end.

If the new index is not outside the hazard cube and a hazard does not exist, the new index may be added to the drilling volume in 1064. In 1066, the saved angle may be set to the distance traveled multiplied by the DLS. In 1068, the node may be moved one index position in the current direction to set a new test index. In 1070, the angle cost may be set to an angle change needed to reach the new test index.

In 1072, the saved angle may be compared to the angle cost to determine if the saved angle may be less than the angle cost. If the saved angle is less than the angle cost, the method 1050 return to 1060 to check the new test index. If the saved angle is greater than the angle cost, a new node may be created, the azimuth and inclination set for the new node, and the new node may be returned for storage in the data structure. The method 1050 may then end.

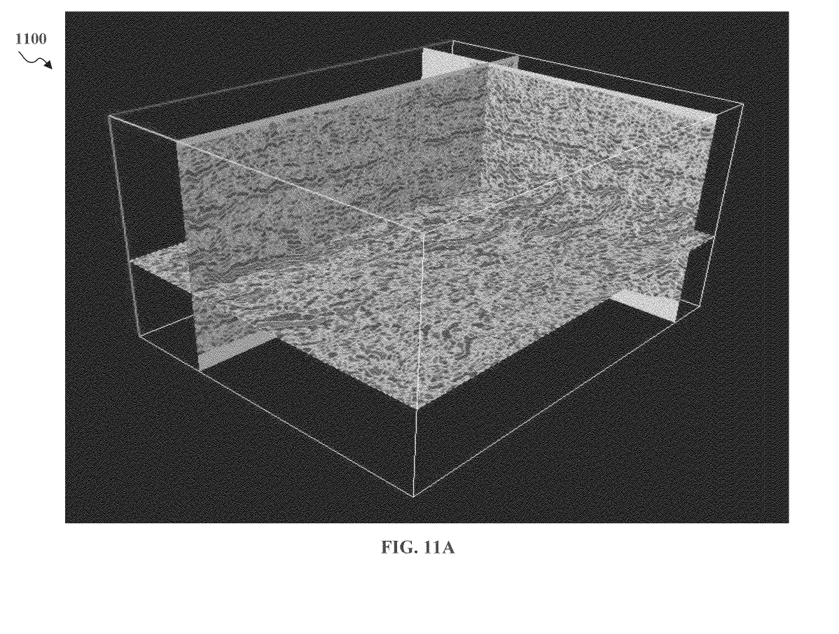

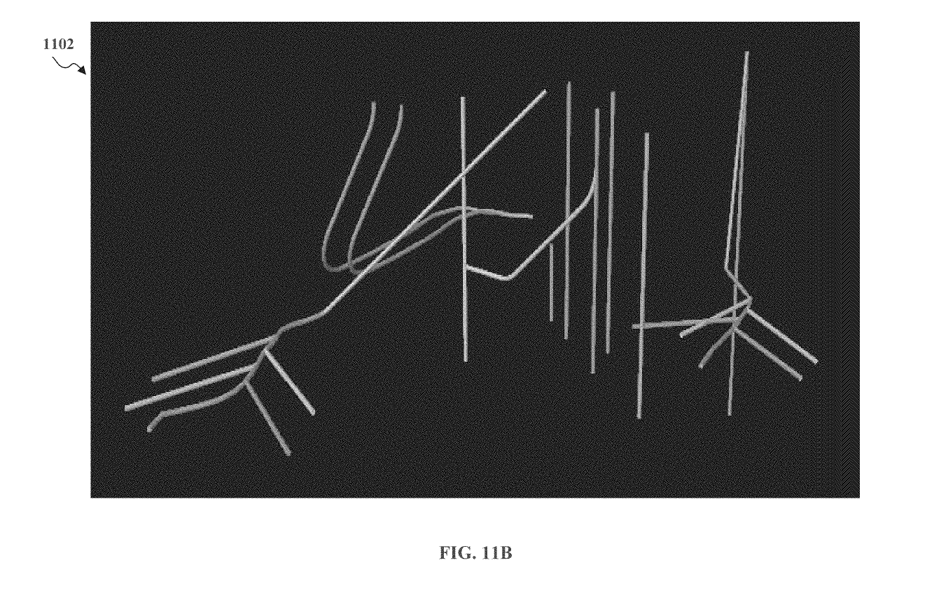

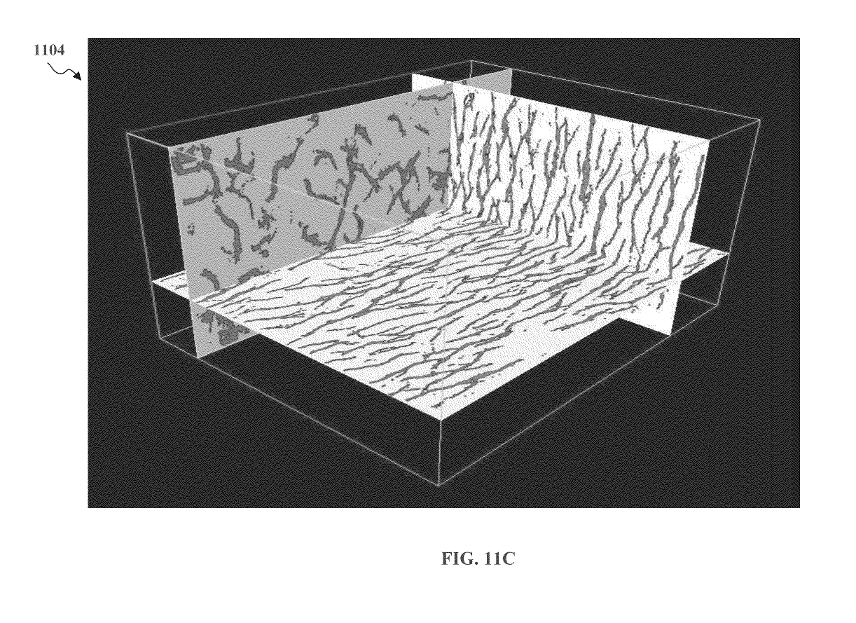

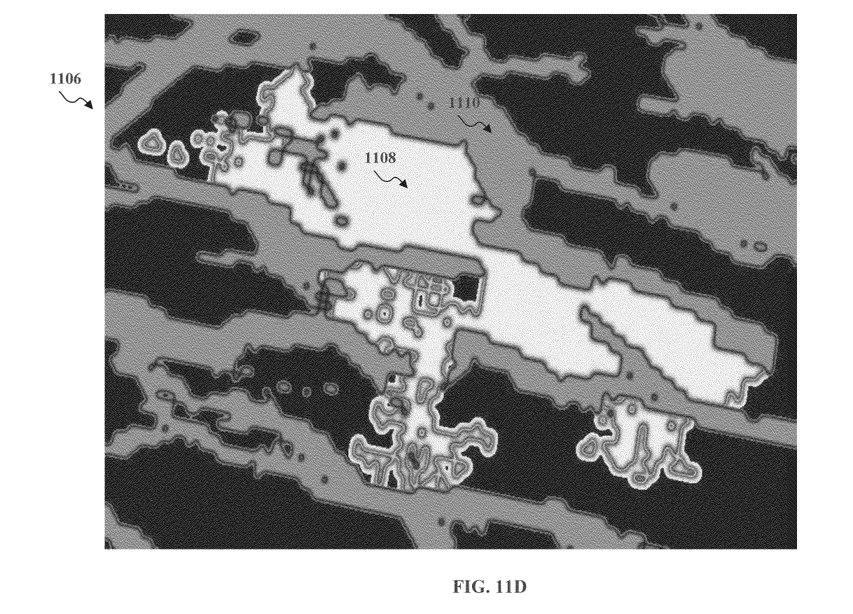

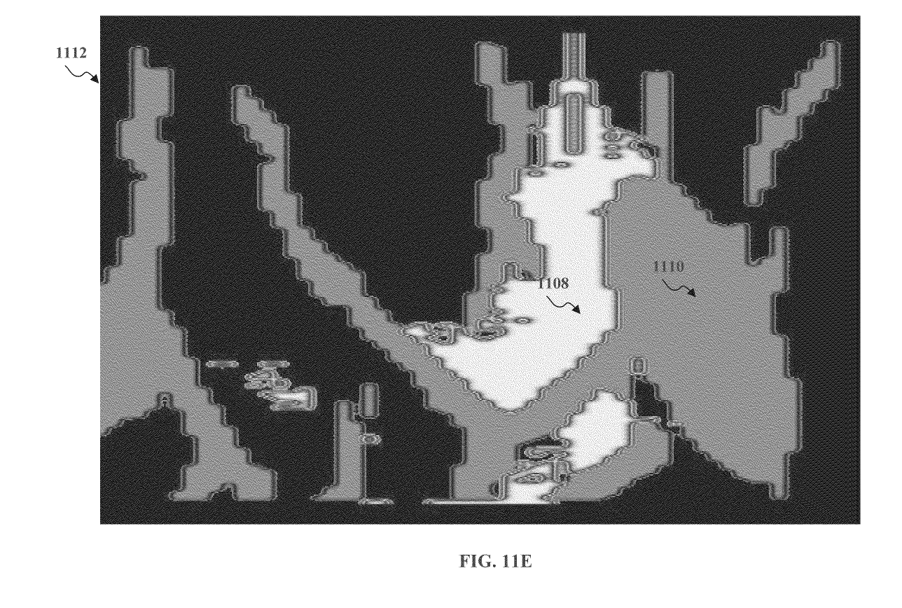

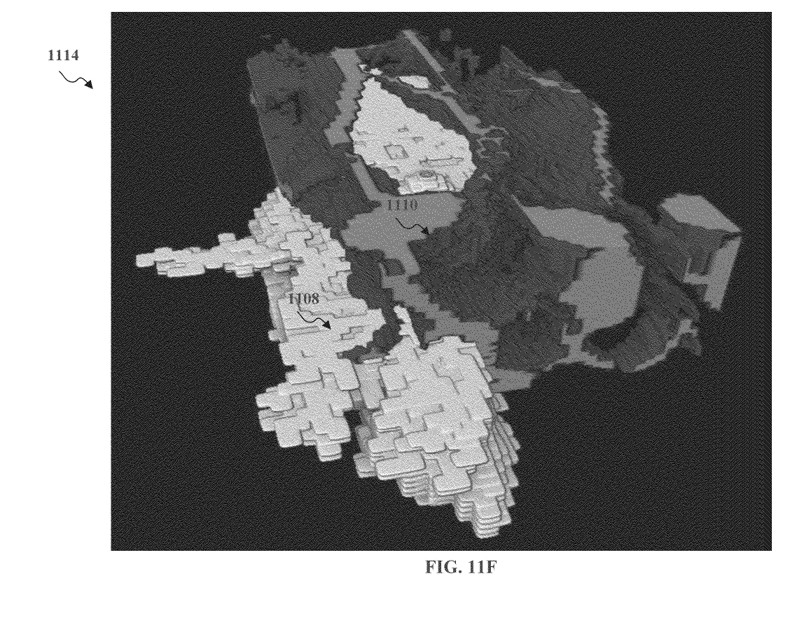

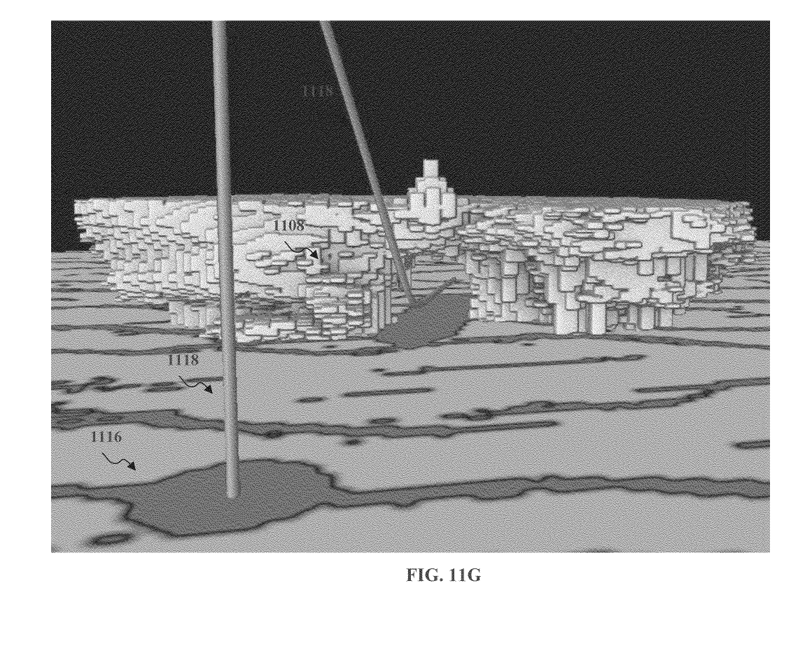

FIGS. 11A to 11G illustrate examples of inputs and outputs into the methods 600 and 1000 described above for evaluating a test field. In these examples, the inputs to create the hazard cube are illustrated in FIGS. 11A, 11B, and 11C. FIG. 11A illustrates an example of a seismic cube 1100 including seismic data. The cube covers an area of approximately 9 km times 7.5 km, with a total depth of approximately 1 km. FIG. 11B illustrates an example positioning and configuration 1102 of 11 existing wells positioned in the field. FIG. 11C illustrates an example a fault cube 1104 generated from the seismic cube 1100.

FIG. 11D illustrates a time slice 1106 of a drilling volume 1108 generated from the input in FIGS. 11A, 11B and 11C. The time slice is viewed from above and the area is heavily faulted 1110 with a few wells nearby. FIG. 11E illustrates a time slice 1112 of the drilling volume 1108. The time slice 1112 is viewed inline.

FIG. 11F illustrates a geobody 1114 of the drilling volume 1108. The geobody 1114 shows the drilling volume 1108 and parts of a larger hazard cube, visualized as geobodies. The image is taken at a slightly tilted angle from above. The start point may be seen in the center of the image. The hazard cube has been cropped so that it does not cover all of the drilling volume. FIG. 11G illustrates a drilling volume 1108 as a geobody, a hazard cube time slice 1116 and two existing wells 1118. The start position is seen at the top of the drilling volume 1108. As illustrated, a hole exists in the center of the drilling volume corresponding to the existing wells 1118.

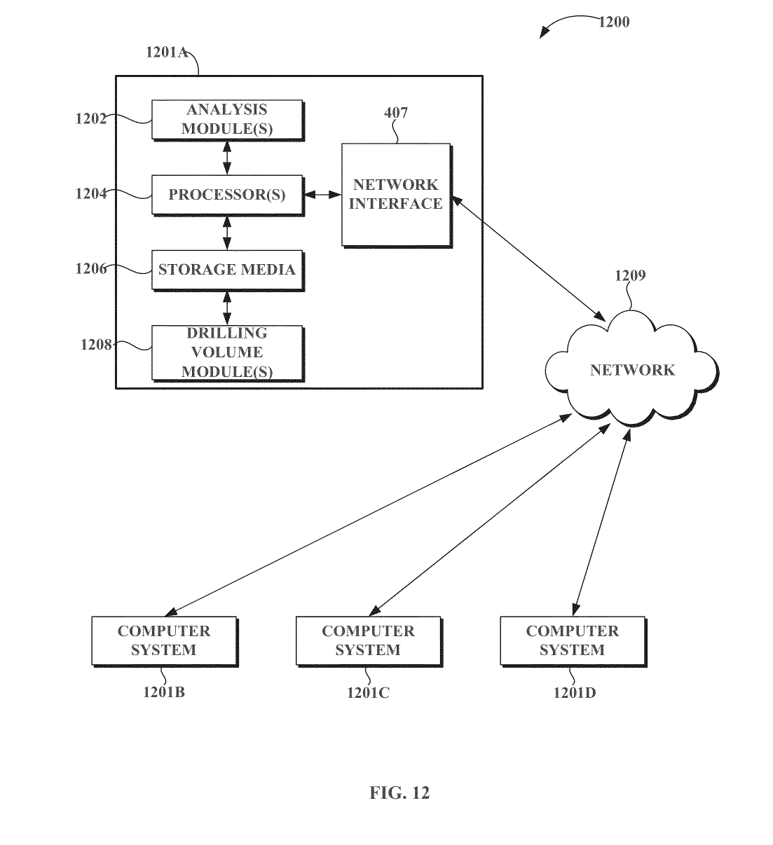

In some embodiments, the methods of the present disclosure may be executed by one or more computing systems. FIG. 12 illustrates an example of such a computing system 1200, in accordance with some embodiments. The computing system 1200 may include a computer or computer system 1201A, which may be an individual computer system 1201A or an arrangement of distributed computer systems. The computer system 1201A includes one or more analysis modules 1202 that are configured to perform various tasks according to some embodiments, such as one or more methods disclosed herein. To perform these various tasks, the license module 1202 executes independently, or in coordination with, one or more processors 1204, which is (or are) connected to one or more storage media 1206. The processor(s) 1204 is (or are) also connected to a network interface 1207 to allow the computer system 1201A to communicate over a data network 1209 with one or more additional computer systems and/or computing systems, such as 1201B, 1201C, and/or 1201D (note that computer systems 1201B, 1201C and/or 1201D may or may not share the same architecture as computer system 1201A, and may be located in different physical locations, e.g., computer systems 1201A and 1201B may be located in a processing facility, while in communication with one or more computer systems such as 1201C and/or 1201D that are located in one or more data centers, and/or located in varying countries on different continents).

A processor may include a microprocessor, microcontroller, processor module or subsystem, programmable integrated circuit, programmable gate array, or another control or computing device.

The storage media 1206 may be implemented as one or more computer-readable or machine-readable storage media. Note that while in the example embodiment of FIG. 12 storage media 1206 is depicted as within computer system 1201A, in some embodiments, storage media 1206 may be distributed within and/or across multiple internal and/or external enclosures of computing system 1201A and/or additional computing systems. Storage media 1206 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLURAY® disks, or other types of optical storage, or other types of storage devices. Note that the instructions discussed above may be provided on one computer-readable or machine-readable storage medium, or alternatively, may be provided on multiple computer-readable or machine-readable storage media distributed in a large system having possibly plural nodes. Such computer-readable or machine-readable storage medium or media is (are) considered to be part of an article (or article of manufacture). An article or article of manufacture may refer to any manufactured single component or multiple components. The storage medium or media may be located either in the machine running the machine-readable instructions, or located at a remote site from which machine-readable instructions may be downloaded over a network for execution.

In some embodiments, computing system 1200 contains drilling volume module 1208. In the example of computing system 1200, computer system 1201A includes the drilling volume module 1208. In some embodiments, a single software tracking module may be used to perform some aspects of one or more embodiments of the methods 600 and 1000 disclosed herein. In alternate embodiments, a plurality of software tracking module may be used to perform some aspects of methods 600 and 1000 herein.

It should be appreciated that computing system 1200 is merely one example of a computing system, and that computing system 1200 may have more or fewer components than shown, may combine additional components not depicted in the example embodiment of FIG. 12, and/or computing system 1200 may have a different configuration or arrangement of the components depicted in FIG. 12. The various components shown in FIG. 12 may be implemented in hardware, software, or a combination of both hardware and software, including one or more signal processing and/or application specific integrated circuits.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are included within the scope of the present disclosure.

The foregoing description, for purpose of explanation, has been described with reference to specific embodiments. However, the illustrative discussions above are not intended to be exhaustive or limiting to the precise forms disclosed. Many modifications and variations are possible in view of the above teachings. Moreover, the order in which the elements of the methods described herein are illustrate and described may be re-arranged, and/or two or more elements may occur simultaneously. The embodiments were chosen and described in order to best explain the principals of the disclosure and its practical applications, to thereby enable others skilled in the art to best utilize the disclosed embodiments and various embodiments with various modifications as are suited to the particular use contemplated.

What is claimed is:

1. A method, comprising:
determining, for a hydrocarbon field, a hazard cube that represents one or more hazards associated with drilling a new well in the hydrocarbon field;
determining one or more drilling constraints for drilling the new well in the hydrocarbon field;
generating a drilling volume for the hydrocarbon field, wherein the drilling volume comprises a representation of one or more areas of the hydrocarbon field that may be drilled to avoid the hazards and satisfy the one or more drilling constraints; and
displaying the drilling volume for analysis by a user.

2. The method of claim 1, wherein the one or more hazards comprise one or more of faults in the hydrocarbon field, a path of an existing well in the hydrocarbon field, or a salt dome in the hydrocarbon field.

3. The method of claim 1, wherein the hazard cube comprises one or more seismic cubes containing seismic data for the one or more hazards.

4. The method of claim 1, the method further comprising:
generating a geobody based at least in part on the drilling volume and a reservoir model that represents reservoir quality of the hydrocarbon field; and
determining, based at least in part on the geobody, one or more drilling paths for the new well that maximize reservoir quality.

5. The method of claim 1, wherein the one or more drilling constraints comprise dogleg severity and starting location of the new well.

6. The method of claim 1, wherein generating the drilling volume comprises:
determining a starting node in a cube;
selecting an index along the start direction from the starting node;
determining whether a hazard in the hazard cube corresponds to the new index;
if a hazard corresponds to the new index:
rejecting the new index from inclusion in the drilling volume; and
if a hazard does not correspond to the new index:
determining whether the new index satisfies at least one of the one or more drilling constraints,
if the new index satisfies at least one of the one or more drilling constraints:
including the new index in the drilling volume, and
selecting a new index in the first direction.

7. The method of claim 6, wherein the first direction comprises one of a vertical direction, a horizontal direction, and a diagonal direction.

8. A non-transitory computer readable storage medium comprising instructions for causing one or more processors to perform a method comprising:
determining, for a hydrocarbon field, a hazard cube that represents one or more hazards associated with drilling a new well in the hydrocarbon field;
determining one or more drilling constraints for drilling the new well in the hydrocarbon field;
generating a drilling volume for the hydrocarbon field, wherein the drilling volume comprises a representation of one or more areas of the hydrocarbon field that may be drilled to avoid the hazards and satisfy the one or more drilling constraints; and
displaying the drilling volume for analysis by a user.

9. The non-transitory computer readable storage medium of claim 8, wherein the one or more hazards comprise one or more of faults in the hydrocarbon field, a path of an existing well in the hydrocarbon field, or a salt dome in the hydrocarbon field.

10. The non-transitory computer readable storage medium of claim 8, wherein the hazard cube comprises one or more seismic cubes containing seismic data for the one or more hazards.

11. The non-transitory computer readable storage medium of claim 8, the method further comprising:
generating a geobody based at least in part on the drilling volume and a reservoir model that represents reservoir quality of the hydrocarbon field; and
determining, based at least in part on the geobody, one or more drilling paths for the new well that maximize reservoir quality.

12. The non-transitory computer readable storage medium of claim 8, wherein the one or more drilling constraints comprise dogleg severity and starting location of the new well.

13. The non-transitory computer readable storage medium of claim 8, wherein generating the drilling volume comprises:
determining a starting node in a cube;
selecting an index along the start direction from the starting node;
determining whether a hazard in the hazard cube corresponds to the new index;
if a hazard corresponds to the new index:
rejecting the new index from inclusion in the drilling volume; and
if a hazard does not correspond to the new index:
determining whether the new index satisfies at least one of the one or more drilling constraints,
if the new index satisfies at least one of the one or more drilling constraints:
including the new index in the drilling volume, and
selecting a new index in the first direction.

14. The non-transitory computer readable storage medium of claim 13, wherein the first direction comprises one of a vertical direction, a horizontal direction, and a diagonal direction.

15. A system comprising:
one or more memory devices storing instructions; and
one or more processors coupled to the one or more memory devices and configured to execute the instructions to perform a method comprising:
determining, for a hydrocarbon field, a hazard cube that represents one or more hazards associated with drilling a new well in the hydrocarbon field;
determining one or more drilling constraints for drilling the new well in the hydrocarbon field;
generating a drilling volume for the hydrocarbon field, wherein the drilling volume comprises a representation of one or more areas of the hydrocarbon field that may be drilled to avoid the hazards and satisfy the one or more drilling constraints; and
displaying the drilling volume for analysis by a user.

16. The system of claim 15, wherein the one or more hazards comprise one or more of faults in the hydrocarbon field, a path of an existing well in the hydrocarbon field, or a salt dome in the hydrocarbon field.

17. The system of claim 15, wherein the hazard cube comprises one or more seismic cubes containing seismic data for the one or more hazards.

18. The system of claim 15, the method further comprising:
generating a geobody based at least in part on the drilling volume and a reservoir model that represents reservoir quality of the hydrocarbon field; and
determining, based at least in part on the geobody, one or more drilling paths for the new well that maximize reservoir quality.

19. The system of claim 15, wherein the one or more drilling constraints comprise dogleg severity and starting location of the new well.

20. The system of claim 15, wherein generating the drilling volume comprises:
determining a starting node in a cube;
selecting an index along the start direction from the starting node;
determining whether a hazard in the hazard cube corresponds to the new index;
if a hazard corresponds to the new index:
rejecting the new index from inclusion in the drilling volume; and
if a hazard does not correspond to the new index:
determining whether the new index satisfies at least one of the one or more drilling constraints,
if the new index satisfies at least one of the one or more drilling constraints:
including the new index in the drilling volume, and
selecting a new index in the first direction.
